(19) United States
(12) Patent Application Publication
(10) Pub. No.: US 2026/0094432 A1
(43) Pub. Date: Apr. 2, 2026

(54) DEVICE AND METHOD FOR PROCESSING CAPTURED IMAGE DATA

(71) Applicant: PANASONIC INTELLECTUAL PROPERTY MANAGEMENT CO., LTD., Osaka (JP)

(72) Inventors: Ichiro TAKEI, Tokyo (JP); Akihiro FURUTA, Kanagawa (JP); Kensho TERANISHI, Osaka (JP)

(73) Assignee: PANASONIC INTELLECTUAL PROPERTY MANAGEMENT CO., LTD., Osaka (JP)

(21) Appl. No.: 19/140,490

(22) PCT Filed: Dec. 7, 2023
(86) PCT No.: PCT/JP2023/043891

§ 371 Date: Jun. 18, 2025

(30) Foreign Application Priority Data
Dec. 19, 2022 (JP) 2022-202568
Dec. 19, 2022 (JP) 2022-202573
Dec. 19, 2022 (JP) 2022-202575

(51) Int. Cl. G06V 10/98; G06T 1/60; G06T 17/05

(52) U.S. Cl. CPC G06V 10/987; G06T 1/60; G06T 17/05; G06T 2200/24

(57) ABSTRACT

A device allows a user to easily identify a region in which accuracy of measurement results is likely to be insufficient, in stored captured image data, thereby enabling effective deletion of captured image data to be deleted. The device displays an image that visualizes a deletion-recommended region in a trajectory connecting imaging spots, based on processing information on a status of performance of a loop closing operation in a 3D measurement operation. The deletion-recommended region is within an unprocessed region for which the loop closing has not been performed, and in which accuracy of measurement results based on image data of the imaging spots, is estimated to be insufficient. The device calculates a distant amount from a loop closing start point to a certain spot, as an indicator of the measurement accuracy, and compares the distant amount with a criterion to determine whether the spot falls within the deletion-recommended region.

### TECHNICAL FIELD

The present disclosure relates to a device, method, and program for processing captured image data which has been acquired by shooting imaging spots in a measurement target site spot by spot with a camera while moving in the measurement target site, thereby allowing a 3D measurement operation to be performed for generating 3D space information on the measurement target site.

### BACKGROUND ART

Known 3D measurement technologies include a technology that generates 3D space information (map data) related to a measurement target site based on captured images thereof. In the field of 3D measurement technology, SLAM (Simultaneous Localization And Mapping) methods have attracted attention in recent years. In such SLAM methods, a mobile vehicle that carries an imaging device is used, and 3D space information and information on the position of the vehicle are generated as measurement results based on captured images of spots of a measurement target site captured by the imaging device. In some SLAM methods, a user carries a portable imaging device, and conducts imaging work by capturing images with the imaging device while moving around a measurement target site, thereby enabling easy 3D measurements.

However, in 3D measurements using such an SLAM method, self-relative-position estimation operations are repeatedly performed, which inevitably results in accumulation of errors. Such accumulation of errors in self-position estimation can cause a significant drop in the accuracy of results of 3D measurements.

When errors occur during the process of creation of 3D space information (map data), one of the prior-art methods for reducing the accuracy degradation caused by such a cumulative error enables the creation of 3D space information (map data) to be restarted from the middle of the process, without having to start from the beginning again (Patent Document 1). This prior-art technology detects an event (lost) that causes an error and presents a period during which the event occurred to a user, which enables the user to identify the position at which to start over with the creation of the 3D space information.

Other methods for reducing the accuracy degradation caused by a cumulative error include loop closing technology (Non-Patent Document 1). A method of the loop closing technology is configured such that, when the trajectory (movement path) of an imaging device forms a loop, i.e., when the imaging device moves and returns to a spot at which an image was previously captured, assuming that the self-position estimation result (past position) acquired based on the image previously captured at the spot is a correct position, the method corrects the positions along the path from the current position to the past position, thereby eliminating the cumulative error. This method can eliminate the need to restart the process of imaging from the middle as the technology disclosed in Patent Document 1.

### PRIOR ART DOCUMENT(S)

### Patent Document(s)

Patent Document 1: JP6639734B

### Non-Patent Document(s)

Non-Patent Document 1: SATO, Tomokazu, “SSII2015 Tutorial, Sequential Three-dimensional Reproduction from Motion Image by Feature Point Tracking, and Application Thereof, from Basics of Coordinate System to Application Case Examples and Recent Research Tendency”, Jun. 10, 2015, Image Sensing Symposium Tutorial Lecture Meeting

### SUMMARY OF THE INVENTION

### Task to be Accomplished by the Invention

In 3D measurements using SLAM methods, the loop closing technology is useful in reducing the accuracy degradation caused by a cumulative error, as disclosed in Non-Patent Document 1.

In a loop closing operation, starting from a loop closing start point, which is an imaging spot where a loop is closed, an operation for correcting the position of each imaging spot is performed spot by spot as if going back in time from the loop closing start point to an imaging start point, i.e., in the opposite direction of movement. As the corrected position of each imaging spot includes an error, this error in position correction for each imaging spot accumulates as the imaging spot to be subjected to position correction goes back in time to the imaging start point. As a result, the accuracy of the position correction gradually decreases. In other words, the accuracy of point cloud image data generated from captured image data at each imaging spot gradually decreases as the imaging spot moves away from the loop closing start point.

In other words, in a region before the loop closing start point, i.e., in a processed region for which the loop closing operation has been performed, the position correction error in the loop closing operation is accumulated, which means that the accuracy of point cloud image data generated from captured image data gradually decreases as the distance from the loop closing start point increases. In a region after the loop closing start point, i.e., in an unprocessed region for which the loop closing operation has not been performed, the error in self-position estimation in a 3D measurement operation is accumulated, which means that the accuracy of point cloud image data generated from captured image data gradually decreases as the distance from the loop closing start point increases.

As described above, even when the loop closing operation is performed, point cloud image data with high accuracy is unlikely to be acquired at points distant from the loop closing start point. In addition, when point cloud image data generated from captured image data at imaging points includes data with low accuracy, the overall accuracy of the point cloud image data can become low, causing problems such as double images.

Thus, in order to generate highly accurate point cloud image data as measurement results, it is desirable to preliminarily delete captured image data that can reduce the accuracy of point cloud image data. However, there is no technology in the prior art that enables effective deletion of data of a region in which accuracy of measurement results is likely to be insufficient in stored captured image data.

The present disclosure has been made in view of this problem of the prior art, and a primary object of the present disclosure is to provide a device, method, and program for processing captured image data which allow a user to easily identify a region in which accuracy of measurement results is likely to be insufficient, in stored captured image data, thereby enabling effective deletion of image data to be deleted.

### Means to Accomplish the Task

An aspect of the present disclosure provides a device for processing captured image data in which a processor processes captured image data which has been acquired by shooting imaging spots in a measurement target site spot by spot with a camera, thereby allowing a 3D measurement operation to be performed for generating 3D space information on the measurement target site, the device comprising: a storage for storing captured image data and processing information as to a status of performance of a loop closing operation in the 3D measurement operation; and a display for displaying a screen that indicates captured image data and the status of performance of the loop closing operation, wherein the processor performs operations to: cause the display to display an image that visualizes a deletion-recommended region in a trajectory connecting imaging spots, based on the processing information, wherein the deletion-recommended region is a region within an unprocessed region for which the loop closing operation has not been performed, and in which accuracy of results of the 3D measurement operation based on captured image data of the imaging spots is estimated to be insufficient.

Another aspect of the present disclosure provides a method for processing captured image data in which a processor processes captured image data which has been acquired by shooting imaging spots in a measurement target site spot by spot with a camera, thereby allowing a 3D measurement operation to be performed for generating 3D space information on the measurement target site, the method comprising: the processor performing an operation to: cause a display to display an image that visualizes a deletion-recommended region in a trajectory connecting imaging spots, based on the processing information, wherein the deletion-recommended region is a region within an unprocessed region for which a loop closing operation in the 3D measurement operation has not been performed, and in which accuracy of results of the 3D measurement operation based on captured image data of the imaging spots is estimated to be insufficient based on processing information as to a status of performance of the loop closing operation.

Yet another aspect of the present disclosure provides a program for processing captured image data that causes a processor to perform operations for processing captured image data which has been acquired by shooting imaging spots in a measurement target site spot by spot with a camera, thereby allowing a 3D measurement operation to be performed for generating 3D space information on the measurement target site, the operations comprising: causing a display to display an image that visualizes a deletion-recommended region in a trajectory connecting imaging spots in the measurement target site, and wherein the deletion-recommended region is a region within an unprocessed region for which a loop closing operation in the 3D measurement operation has not been performed, and in which accuracy of results of the 3D measurement operation based on captured image data of the imaging spots is estimated to be insufficient based on processing information as to a status of performance of the loop closing operation.

### EFFECT OF THE INVENTION

According to the present disclosure, presented to a user is an image that visualizes a deletion-recommended region in a trajectory connecting imaging spots, wherein the deletion-recommended region is within an unprocessed region for which the loop closing operation has not been performed, and in which accuracy of measurement results is estimated to be insufficient. This allows the user to easily identify a region in which accuracy of measurement results is likely to be insufficient, in stored captured image data, thereby enabling effective deletion of captured image data to be deleted.

### BRIEF DESCRIPTION OF THE DRAWINGS

FIG. 1 is an explanatory diagram showing a status of imaging work using an imaging device in accordance with an embodiment of the present disclosure;

FIG. 2 is a plan view showing a measurement target site (i.e., a site to be measured);

FIG. 3 is an explanatory diagram showing a bird's-eye point cloud trajectory image as a map image of a first example;

FIG. 4 is an explanatory diagram showing a bird's-eye trajectory image as a map image of the first example;

FIG. 5 is an explanatory diagram showing a bird's-eye trajectory image as a map image of a second example;

FIG. 6 is an explanatory diagram showing a bird's-eye trajectory image as a map image of a third example;

FIG. 7 is an explanatory diagram showing a bird's-eye trajectory image as a map image of a fourth example;

FIG. 8 is an explanatory diagram showing a bird's-eye trajectory image of a fifth example of the map image;

FIG. 9 is an explanatory diagram showing examples of timeline images;

FIG. 10 is an explanatory diagram showing examples of timeline images;

FIG. 11 is a block diagram showing a schematic configuration of an imaging device;

FIG. 12 is a flowchart showing a procedure of region determination operation;

FIG. 13 is an explanatory diagram showing an imaging screen displayed on a display; and

FIG. 14 is an explanatory diagram showing an image data adjuster screen displayed on the display.

### DESCRIPTION OF THE PREFERRED EMBODIMENT(S)

A first aspect of the present disclosure made to achieve the above-described object is a device for processing captured image data in which a processor processes captured image data which has been acquired by shooting imaging spots in a measurement target site spot by spot with a camera, thereby allowing a 3D measurement operation to be performed for generating 3D space information on the measurement target site, the device comprising: a storage for storing captured image data and processing information as to a status of performance of a loop closing operation in the 3D measurement operation; and a display for displaying a screen that indicates captured image data and the status of performance of the loop closing operation, wherein the processor performs operations to: cause the display to display an image that visualizes a deletion-recommended region in a trajectory connecting imaging spots, based on the processing information, wherein the deletion-recommended region is a region within an unprocessed region for which the loop closing operation has not been performed, and in which accuracy of results of the 3D measurement operation based on captured image data of the imaging spots is estimated to be insufficient.

According to this configuration, the device presents to a user an image that visualizes a deletion-recommended region in a trajectory connecting imaging spots, wherein the deletion-recommended region is within an unprocessed region for which the loop closing operation has not been performed, and in which accuracy of measurement results is estimated to be insufficient. This allows the user to easily identify a region in which accuracy of measurement results is likely to be insufficient, in stored captured image data, thereby enabling effective deletion of captured image data to be deleted.

A second aspect of the present disclosure is the device, wherein the operations performed by the processor comprise: calculating a distant amount from a start point of the loop closing operation to a target imaging spot, as an indicator of the accuracy of results of the 3D measurement operation based on captured image data of the imaging spots; and comparing the distant amount for the target imaging spot with a criterion predetermined for the unprocessed region to thereby determine whether or not the imaging spot falls within the deletion-recommended region.

This configuration enables the proper determination of the deletion-recommended region. When there are two or more regions that form loops and the loop closing operation has been performed twice or more, the distant amount is preferably calculated from the start point of the last loop closing operation.

A third aspect of the present disclosure is the device, wherein the operations performed by the processor comprise: visualizing the deletion-recommended region and the other region in the trajectory in the unprocessed region in different display forms.

This configuration allows a user to easily distinguish between the deletion-recommended region and the other region (acceptable accuracy region).

A fourth aspect of the present disclosure is the device, wherein the difference in the display form includes at least one of different colors, patterns or animations.

This configuration allows a user to easily distinguish between the deletion-recommended region and the other region (acceptable accuracy region). In this case, types of the pattern include line styles and designs. Types of animations include blinking.

A fifth aspect of the present disclosure is the device, wherein the operations performed by the processor comprise calculating, as the distant amount, any one of the followings: a time which has elapsed from when the start point of the loop closing operation was imaged to when the target imaging spot is imaged; a distance between the start point of the loop closing operation and the target imaging spot; a shooting count which is a number of times the shooting has been performed between the start point of the loop closing operation and the target imaging spot; and a key frame count which is a number of key frames of an SLAM method captured between the start point of the loop closing operation and the target imaging spot.

This configuration enables the proper determination of the deletion-recommended region based on the distant amount.

A sixth aspect of the present disclosure is the device, wherein the operations performed by the processor comprise visualizing the deletion-recommended region in the trajectory in both the unprocessed region, for which the loop closing operation has not been performed, and a processed region for which the loop closing operation has been performed.

This configuration presents to a user the deletion-recommended in the processed region, for which the loop closing operation has been performed, as well as the deletion-recommended in the unprocessed region, for which the loop closing operation has not been performed.

A seventh aspect of the present disclosure is a device for processing captured image data in which a processor processes captured image data which has been acquired by shooting imaging spots in a measurement target site spot by spot with a camera, thereby allowing a 3D measurement operation to be performed for generating 3D space information on the measurement target site, the device comprising: a storage for storing captured image data and processing information as to a status of performance of a loop closing operation in the 3D measurement operation; and a display for displaying a screen that indicates captured image data and the status of performance of the loop closing operation, wherein the processor performs operations to: cause the display to display an image that visualizes a deletion-recommended region in a trajectory connecting imaging spots, based on the processing information, wherein the deletion-recommended region is a region within a processed region for which the loop closing operation has been performed, and in which accuracy of results of the 3D measurement operation based on captured image data of the imaging spots is estimated to be insufficient.

In this configuration, the device presents to a user an image that visualizes a deletion-recommended region in a trajectory connecting imaging spots, wherein the deletion-recommended region is within an unprocessed region for which the loop closing operation has not been performed, and in which accuracy of measurement results is estimated to be insufficient. This allows the user to easily identify a region in which accuracy of measurement results is likely to be insufficient, in stored captured image data, thereby enabling effective deletion of captured image data to be deleted.

The device of the seventh aspect of the present disclosure may be configured such that the operations performed by the processor comprise: calculating a distant amount from a start point of the loop closing operation to a target imaging spot, as an indicator of the accuracy of results of the 3D measurement operation based on captured image data of the imaging spots; and comparing the distant amount for the target imaging spot with a criterion predetermined for the unprocessed region to thereby determine whether or not the imaging spot falls within the deletion-recommended region.

This configuration enables the accurate determination of the deletion-recommended region. When there are two or more regions that form loops and the loop closing operation has been performed twice or more, the distant amount is preferably calculated from the start point of the last loop closing operation.

The device of the seventh aspect of the present disclosure may be configured such that wherein the operations performed by the processor comprise: visualizing the deletion-recommended region and the other region in the trajectory in the unprocessed region in different display forms.

This configuration allows a user to easily distinguish between the deletion-recommended region and the other region (high accuracy region).

The device of the seventh aspect of the present disclosure may be configured such that wherein the difference in the display form includes at least one of different colors, patterns or animations.

This configuration allows a user to easily distinguish between the deletion-recommended region and the other region (high accuracy region). In this case, types of the pattern include line styles and designs. Types of animations include blinking.

The device of the seventh aspect of the present disclosure may be configured such that the operations performed by the processor comprise calculating, as the distant amount, any one of the followings: a time which has elapsed from when the start point of the loop closing operation was imaged to when the target imaging spot is imaged; a distance between the start point of the loop closing operation and the target imaging spot; a shooting count which is a number of times the shooting has been performed between the start point of the loop closing operation and the target imaging spot; and a key frame count which is a number of key frames of an SLAM method captured between the start point of the loop closing operation and the target imaging spot.

This configuration enables the proper determination of the deletion-recommended region based on the distant amount.

The device of the seventh aspect of the present disclosure may be configured such that the operations performed by the processor comprise visualizing the deletion-recommended region in the trajectory in both the processed region, for which the loop closing operation has been performed, and the unprocessed region, for which the loop closing operation has not been performed.

This configuration presents to a user the deletion-recommended in the unprocessed region, for which the loop closing operation has not been performed, as well as the deletion-recommended in the processed region, for which the loop closing operation has been performed.

An eighth aspect of the present disclosure is a device for processing captured image data in which a processor processes captured image data which has been acquired by shooting imaging spots in a measurement target site spot by spot with a camera, thereby allowing a 3D measurement operation to be performed for generating 3D space information on the measurement target site, the device comprising: a storage for storing captured image data and processing information as to a status of performance of a loop closing operation in the 3D measurement operation; and a display for displaying a screen that indicates captured image data and the status of performance of the loop closing operation, wherein the processor performs operations to: cause the display to display a screen indicating an image data adjuster for adjusting the captured image data stored and accumulated in the storage, wherein the image data adjuster includes an image that visualizes accuracy of results of the 3D measurement operation based on captured image data of the imaging spots; and in response to a user's operation on the image data adjuster to designate a deletion region, delete the captured image data included in the deletion region.

This configuration allows a user to check an image that visualizes the accuracy of measurement results and designate a region to be deleted in the captured image data. This allows the user to easily identify a region in which accuracy of measurement results is likely to be insufficient, in stored captured image data, thereby enabling effective deletion of captured image data to be deleted.

The device of the eighth aspect of the present disclosure may be configured such that the operations performed by the processor comprise: causing the display to display the image data adjuster including a map image that visualizes the accuracy of results of the 3D measurement operation based on captured image data of the imaging spots, along a trajectory connecting imaging spots; and in response to a user's operation on the map image to designate the deletion region, delete the captured image data included in the deletion region.

This configuration allows a user to properly designate a region to be deleted in the captured image data. In this case, the map image may be divided into two or more regions according to the accuracy of measurement results based on captured image data for the imaging spots.

The device of the eighth aspect of the present disclosure may be configured such that the operations performed by the processor comprise: causing the display to display the image data adjuster including a timeline image that visualizes the accuracy of results of the 3D measurement operation based on captured image data of the imaging spots, along a time axis; and in response to a user's operation on the timeline image to designate the deletion region, delete the captured image data included in the deletion region.

This configuration allows a user to properly designate a region to be deleted in the captured image data. In this case, the device may set two or more regions in the timeline image according to the accuracy of measurement results based on captured image data for each imaging spot.

The device of the eighth aspect of the present disclosure may be configured such that the operations performed by the processor comprise in response to a user's operation on the timeline image to designate an image capturing time, causing the display to display a screen including a captured image acquired at the designated image capturing time with the camera.

This configuration allows a user to, from a captured image, visually check a status of image capturing at the user's designated image capturing time (imaging time, imaging position).

The device of the eighth aspect of the present disclosure may be configured such that the operations performed by the processor comprise: determining, based on the processing information, a deletion-recommended region in which accuracy of results of the 3D measurement operation based on captured image data of the imaging spots is estimated to be insufficient; and causing the display to display a screen including an image that visualizes the deletion-recommended region.

This configuration allows a user to easily identify a region in which accuracy of measurement results is likely to be insufficient.

The device of the eighth aspect of the present disclosure may be configured such that the operations performed by the processor comprise: causing the display to display a screen including an operation part which allows a user to instruct the processor to perform an all-delete operation; and in response to the user's operation on the operation part, performing the all-delete operation to delete all captured image data included in the deletion-recommended region.

This configuration allows a user to easily delete captured image data included in the deletion-recommended region. In particular, when there are two or more deletion-recommended regions, this configuration enables the deletion of captured image data included in those deletion-recommended regions at one time.

The device of the eighth aspect of the present disclosure may be configured such that the operations performed by the processor comprise: causing the display to display a screen including an entry field which allows a user to enter a threshold value serving as a criterion on which to determine a deletion-recommended region; and in response to the user's entry of a value in the entry field, setting the value as the entered threshold value.

This configuration allows a user to set a desired threshold value which is a criterion for the determination of deletion-recommended region. In this case, the screen may include two entry fields that allow a user to enter two different values: one is a first threshold value serving as a deletion-recommended-region criterion for an unprocessed region, for which the loop closing operation has not been performed, and the other is a second threshold value serving as a deletion-recommended-region criterion for a processed region, for which the loop closing operation has been performed.

A ninth aspect of the present disclosure is a method for processing captured image data in which a processor processes captured image data which has been acquired by shooting imaging spots in a measurement target site spot by spot with a camera, thereby allowing a 3D measurement operation to be performed for generating 3D space information on the measurement target site, the method comprising: the processor performing an operation to: cause a display to display an image that visualizes a deletion-recommended region in a trajectory connecting imaging spots, based on the processing information, wherein the deletion-recommended region is a region within an unprocessed region for which a loop closing operation in the 3D measurement operation has not been performed, and in which accuracy of results of the 3D measurement operation based on captured image data of the imaging spots is estimated to be insufficient based on processing information as to a status of performance of the loop closing operation.

Similarly to the first aspect, this configuration allows a user to easily identify a region in which accuracy of measurement results is likely to be insufficient, in stored captured image data, thereby enabling effective deletion of captured image data to be deleted.

A tenth aspect of the present disclosure is a method for processing captured image data in which a processor processes captured image data which has been acquired by shooting imaging spots in a measurement target site spot by spot with a camera, thereby allowing a 3D measurement operation to be performed for generating 3D space information on the measurement target site, the method comprising: the processor performing an operation to: cause a display to display an image that visualizes a deletion-recommended region in a trajectory connecting imaging spots, based on the processing information, wherein the deletion-recommended region is a region within a processed region for which a loop closing operation in the 3D measurement operation has been performed, and in which accuracy of results of the 3D measurement operation based on captured image data of the imaging spots is estimated to be insufficient based on processing information as to a status of performance of the loop closing operation.

Similarly to the seventh aspect, this configuration allows a user to easily identify a region in which accuracy of measurement results is likely to be insufficient, in stored captured image data, thereby enabling effective deletion of captured image data to be deleted.

An eleventh aspect of the present disclosure is a method for processing captured image data in which a processor processes captured image data which has been acquired by shooting imaging spots in a measurement target site spot by spot with a camera, thereby allowing a 3D measurement operation to be performed for generating 3D space information on the measurement target site, the method comprising: the processor performing operations to: cause a display to display a screen indicating an image data adjuster for adjusting the captured image data stored and accumulated in a storage, wherein the image data adjuster includes an image that visualizes accuracy of results of the 3D measurement operation based on captured image data of the imaging spots; and in response to a user's operation on the image data adjuster to designate a deletion region, delete the captured image data included in the deletion region.

Similarly to the eighth aspect, this configuration allows a user to easily identify a region in which accuracy of measurement results is likely to be insufficient, in stored captured image data, thereby enabling effective deletion of captured image data to be deleted.

A twelfth aspect of the present disclosure is a program for processing captured image data that causes a processor to perform operations for processing captured image data which has been acquired by shooting imaging spots in a measurement target site spot by spot with a camera, thereby allowing a 3D measurement operation to be performed for generating 3D space information on the measurement target site, the operations comprising: causing a display to display an image that visualizes a deletion-recommended region in a trajectory connecting imaging spots in the measurement target site, and wherein the deletion-recommended region is a region within an unprocessed region for which a loop closing operation in the 3D measurement operation has not been performed, and in which accuracy of results of the 3D measurement operation based on captured image data of the imaging spots is estimated to be insufficient based on processing information as to a status of performance of the loop closing operation.

Similarly to the first aspect, this configuration allows a user to easily identify a region in which accuracy of measurement results is likely to be insufficient, in stored captured image data, thereby enabling effective deletion of captured image data to be deleted.

A thirteenth aspect of the present disclosure is a program for processing captured image data that causes a processor to perform operations for processing captured image data which has been acquired by shooting imaging spots in a measurement target site spot by spot with a camera, thereby allowing a 3D measurement operation to be performed for generating 3D space information on the measurement target site, the operations comprising: causing a display to display an image that visualizes a deletion-recommended region in a trajectory connecting imaging spots, based on the processing information, wherein the deletion-recommended region is a region within a processed region for which a loop closing operation in the 3D measurement operation has been performed, and in which accuracy of results of the 3D measurement operation based on captured image data of the imaging spots is estimated to be insufficient based on processing information as to a status of performance of the loop closing operation.

Similarly to the seventh aspect, this configuration allows a user to easily identify a region in which accuracy of measurement results is likely to be insufficient, in stored captured image data, thereby enabling effective deletion of captured image data to be deleted.

A fourteenth aspect of the present disclosure is a program for processing captured image data that causes a processor to perform operations for processing captured image data which has been acquired by shooting imaging spots in a measurement target site spot by spot with a camera, thereby allowing a 3D measurement operation to be performed for generating 3D space information on the measurement target site, the operations comprising: causing a display to display a screen indicating an image data adjuster for adjusting the captured image data stored and accumulated in a storage, wherein the image data adjuster includes an image that visualizes accuracy of results of the 3D measurement operation based on captured image data of the imaging spots; and in response to a user's operation on the image data adjuster to designate a deletion region, deleting the captured image data included in the deletion region.

Similarly to the eighth aspect, this configuration allows a user to easily identify a region in which accuracy of measurement results is likely to be insufficient, in stored captured image data, thereby enabling effective deletion of captured image data to be deleted.

Embodiments of the present disclosure will be described below with reference to the drawings.

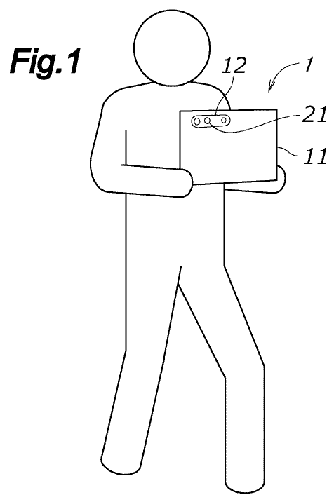

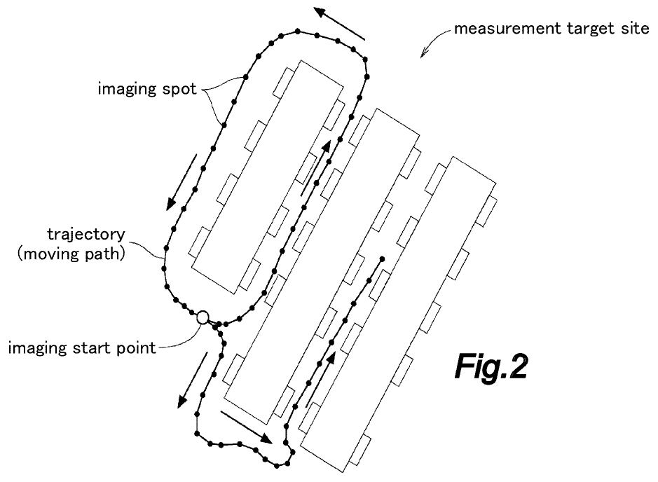

FIG. 1 is an explanatory diagram showing a status of imaging work using an imaging device 1 in accordance with an embodiment of the present disclosure. FIG. 2 is a plan view showing a measurement target site (i.e., a site to be measured).

The imaging device 1 includes an imaging device body 11 and a sensor device 12. The sensor device 12 is equipped with a visible ray camera 21 (imaging module). The visible ray camera 21 is a monocular camera that detects visible light to capture an image of a subject, and outputs captured images, such as RGB color images. In addition, the imaging device 1 may be configured with a tablet terminal or a laptop PC.

A user (worker) walks around a measurement target site while holding the imaging device body 11 of the imaging device 1. The visible ray camera 21 of the imaging device 1 is caused to capture images of spots in the measurement target site on a spot-by-spot basis.

Captured image data includes captured images, sensor detection results, times of shotting, and features extracted from captured images. In the present embodiment, captured image data is acquired by a user holding the imaging device body 11 while walking around the measurement target site. In other embodiments, captured image data may be acquired by using an autonomous mobile robot equipped with the imaging device 1 that moves around the measurement target site.

In the present embodiment, the imaging device 1 is a 3D measurement device. In other words, the imaging device 1 performs 3D measurement operations based on the captured image data of the spots acquired by the visible ray camera 21 on a spot-by-spot basis, to thereby generate 3D space information on the measurement target site. The 3D measurement operations are performed to generate point cloud image data (environmental map) as 3D space information on the measurement target site using an SLAM method. In addition to providing the point cloud image data, the 3D measurement operations involve a self-position estimation operation to estimate self-positions; that is, positions of imaging spots.

The imaging device 1 performs a loop closing operation upon detecting that the trajectory of the device forms a loop, i.e., that the device has returned to a spot where an image has been previously captured. In the loop closing operation, assuming that a result of self-position estimation operation (i.e., a past position acquired at the time of previous imaging) is a correct position of the previously imaged spot, correction is made to the position of each of the imaged spots on the trajectory from the current position to the past position.

In the embodiment shown in FIG. 2, the imaging device starts imaging of spots from an imaging start point and then moves around part of the measurement target site, before returning to the start point. The imaging device then continues to image another area in the measurement target site. In this case, the loop closing operation is performed when the imaging device returns to the imaging start point. This improves the accuracy of point cloud image data and results of the self-position estimation operation for each imaging spot in the loop.

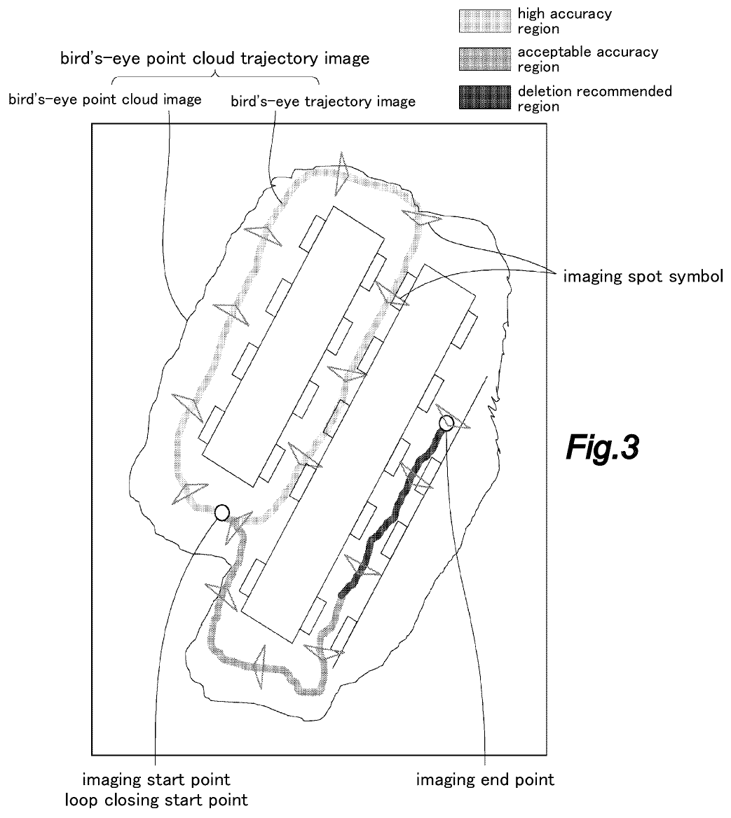

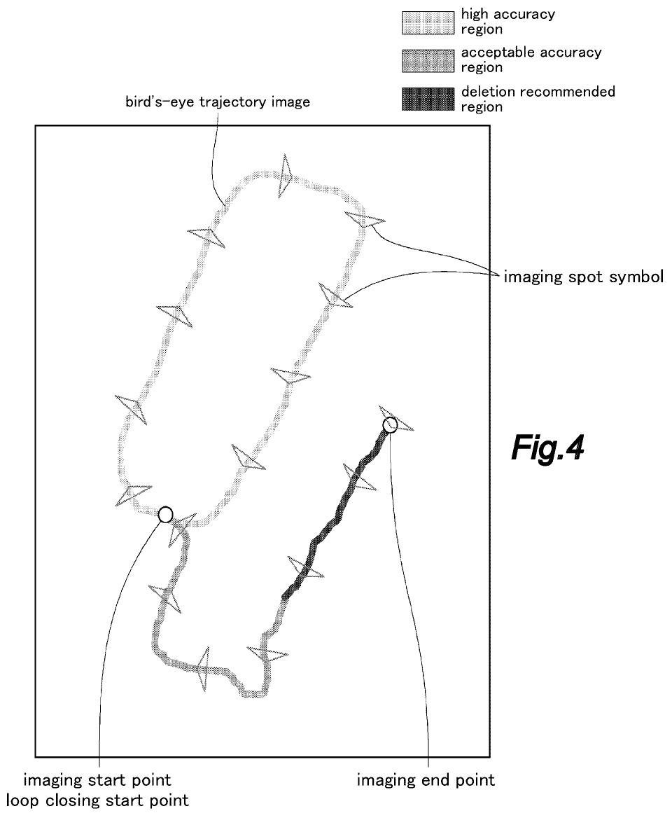

Next, a map image will be described. First, map images as a first example will be described. FIG. 3 is an explanatory diagram showing a bird's-eye point cloud trajectory image as a map image of the first example. FIG. 4 is an explanatory diagram showing a bird's-eye trajectory image as a map image of the first example.

In a loop closing operation, starting from a loop closing start point, which is an imaging spot where a loop is closed, an operation for correcting the position of each imaging spot is performed spot by spot as if going back in time from the loop closing start point to an imaging start point, i.e., in the opposite direction of movement. As the corrected position of each imaging spot includes an error, this error in position correction for each imaging spot accumulates as the imaging spot to be subjected to position correction goes back in time to the imaging start point. As a result, the accuracy of the position correction gradually decreases. In other words, the accuracy of point cloud image data generated from captured image data at each imaging spot gradually decreases as the imaging spot moves away from the loop closing start point.

In this way, in a region before the loop closing start point, i.e., in a processed region for which the loop closing operation has been performed, the position correction error in the loop closing operation is accumulated, which means that the accuracy of point cloud image data generated from captured image data gradually decreases as the distance from the loop closing start point increases.

In a region after the loop closing start point, i.e., in an unprocessed region for which the loop closing operation has not been performed, the error in self-position estimation in a 3D measurement operation is accumulated, which means that the accuracy of point cloud image data generated from captured image data gradually decreases as the distance from the loop closing start point increases.

As described above, even when the loop closing operation is performed, point cloud image data with high accuracy is unlikely to be acquired at points distant from the loop closing start point. In addition, when point cloud image data generated from captured image data at imaging points includes data with low accuracy, the overall accuracy of the point cloud image data can become low, causing problems such as double images.

Thus, in the present embodiment, in order to generate highly accurate point cloud image data as measurement results, captured image data that can reduce the accuracy of point cloud image data is preliminarily deleted. In particular, the device of the present disclosure presents an image that visualizes a status of the accuracy of point cloud image data generated from captured image data of each imaging spot, allowing a user to visually check the data accuracy status.

In the present embodiment, the device calculates a distant amount from a start point of the loop closing operation to a target imaging spot, as an indicator of the accuracy of point cloud image data generated from captured image data of the imaging spots.

The distant amount may be a time which has elapsed from when the start point of the loop closing operation was imaged to when the target imaging spot is imaged. The distant amount may be a distance (distance along a trajectory) between the start point of the loop closing operation and the target imaging spot. The distant amount may be a shooting count which is a number of times the shooting has been performed between the start point of the loop closing operation and the target imaging spot. The distant amount may be a key frame count which is a number of key frames of an SLAM method captured between the start point of the loop closing operation and the target imaging spot.

In the present embodiment, based on the distant amount calculated for each imaging spot, the device determines which of the high accuracy region, acceptable accuracy region, and deletion-recommended region each imaging spot (time of imaging) is categorized to (region determination operation). Specifically, the device compares the distant amount of each imaging spot with a predetermined criterion to determine whether each imaging spot falls into the high accuracy region, acceptable accuracy region, or deletion-recommended region.

In this region determination operation, the device determines whether the loop closing operation has been performed at each imaging spot, i.e., whether each imaging spot is included in an unprocessed region for which the loop closing operation has not been performed or in a processed region for which the loop closing operation has been performed. When a target imaging spot is included in the unprocessed region, for which the loop closing operation has not been performed, the device uses a determination criterion (first threshold) for the unprocessed region. When a target imaging spot is included in the processed region, for which the loop closing operation has been performed, the device uses a determination criterion (second threshold) for the processed region.

The high accuracy region is a region for which the loop closing operation has been performed and which is within such a not-so-far distance from the loop closing start point, that point cloud image data generated from captured image data to be estimated to have high accuracy. The acceptable accuracy region is a region for which the loop closing operation has not been performed, but which is within such a not-so-far distance from the loop closing start point, that the accuracy of point cloud image data generated from captured image data of imaging spots within the region is estimated to be acceptable. The deletion-recommended region is a region for which the loop closing operation has not been performed and which is so distant from the loop closing start point, that the accuracy of point cloud image data generated from captured image data of imaging spots within the region is estimated to be insufficient.

In this way, the device of the present embodiment calculates a distant amount for each imaging spot, which serves as an indicator of the accuracy of point cloud image data (measurement results) generated from captured image data of the spot. Based on the distant amount for the each imaging spot, the device presents to a user an image that visualizes the accuracy of point cloud image data generated from captured image data of the imaging spots along a trajectory connecting imaging spots from the imaging start point to the imaging end point.

As described above, the device of the present embodiment performs the region determination operation to determine whether each imaging spot falls into the high accuracy region, acceptable accuracy region, or deletion-recommended region. Based on the result of determination, the device sets the high accuracy region, acceptable accuracy region, and deletion-recommended region in the trajectory. In other words, the trajectory is divided into the high accuracy region, acceptable accuracy region, and deletion-recommended region. Then, the high accuracy region, acceptable accuracy region, and deletion-recommended region in the trajectory are visualized in different colors.

In the map image shown in FIG. 3, the high accuracy region, acceptable accuracy region, and deletion-recommended region in the bird's-eye point cloud trajectory image are visualized in different colors. In the map image shown in FIG. 4, the high accuracy region, acceptable accuracy region, and deletion-recommended region in the bird's-eye trajectory image are visualized in different colors. A bird's-eye point cloud trajectory image is a composite of a bird's-eye point cloud image and a bird's-eye trajectory image. A bird's-eye point cloud image is an image (rendered image) of points in point cloud image data, seen from an overhead viewpoint. A bird's-eye trajectory image is an image seen from an overhead viewpoint including a line that represents a trajectory connecting self-position estimation results based on the captured image data including each captured image (i.e., a trajectory connecting the imaging spots).

In the bird's-eye trajectory image, the high accuracy region, acceptable accuracy region, and deletion-recommended region set in a trajectory are visualized in different colors. For example, the high accuracy region and acceptable accuracy region are visualized in light blue and green, respectively, and the deletion-recommended region is visualized in red. This configuration allows a user to check a status of the accuracy of point cloud image data generated from captured image data of each imaging spot.

In the map images of the first example shown in FIGS. 3 and 4, there is a region where the trajectory forms a loop (loop region) followed by a region where the trajectory does not form a loop (non-loop region). In the loop region, the loop closing operation has been performed, and position correction has been performed throughout the entire trajectory in the region. For this reason, the loop region is set as a high accuracy region. In the non-loop region where the trajectory does not form a loop, the loop closing operation has not been performed. In the non-loop region, the accuracy is highest at the loop closing start point is highest, and decreases as the distance therefrom increases. Thus, a region near the loop closing start point is set as the acceptable accuracy region, and a region distant from the loop closing start point is set as the deletion-recommended region.

In the present embodiment, regions divided depending on the accuracy of point cloud image data (measurement results) generated from captured image data of the imaging spots (high accuracy region, acceptable accuracy region, and deletion-recommended region) are visualized in different colors. In some cases, the deletion-recommended region and the other region in the trajectory may be visualized in different display forms other than colors. For example, the difference in the display form may include different patterns or animations. In this case, types of the pattern include line styles and designs. Types of animations include blinking.

In the present embodiment, the accuracy of point cloud image data generated from captured image data of each imaging spot is visualized in a discontinuous manner by dividing the point cloud image data into a plurality of regions based on the accuracy. However, in other cases, a trajectory image may be formed with a grayscale that can be continuously changed according to the accuracy of point cloud image data generated from captured image data of each imaging spot, so that the accuracy of the point cloud image data is expressed in a continuous manner.

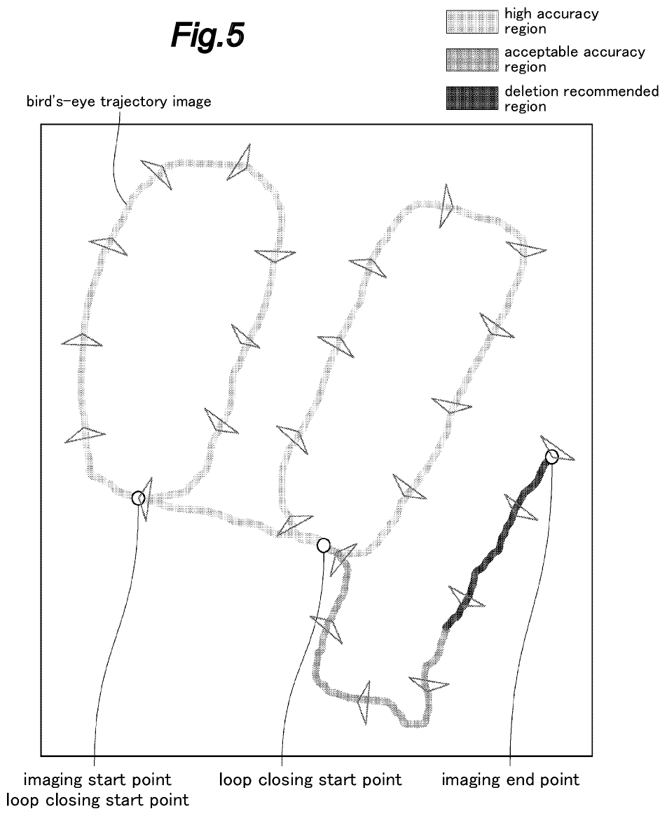

Next, a map image of a second example will be described. FIG. 5 is an explanatory diagram showing a bird's-eye trajectory image as a map image of the second example.

In the map image shown in FIG. 5, there are two regions where the trajectory forms loops (loop regions) and thus the loop closing operation is performed twice. A region before the start point of the last loop closing operation, i.e., a region consisting of the two loop regions and a region therebetween, is set as the high accuracy region.

For a region after the start point of the last loop closing operation, i.e., a region for which the loop closing operation has not been performed, similarly to the map images of the first example (FIGS. 3 and 4), a region near the loop closing start point is set as the acceptable accuracy region, and a region distant from the loop closing start point is set as the deletion-recommended region.

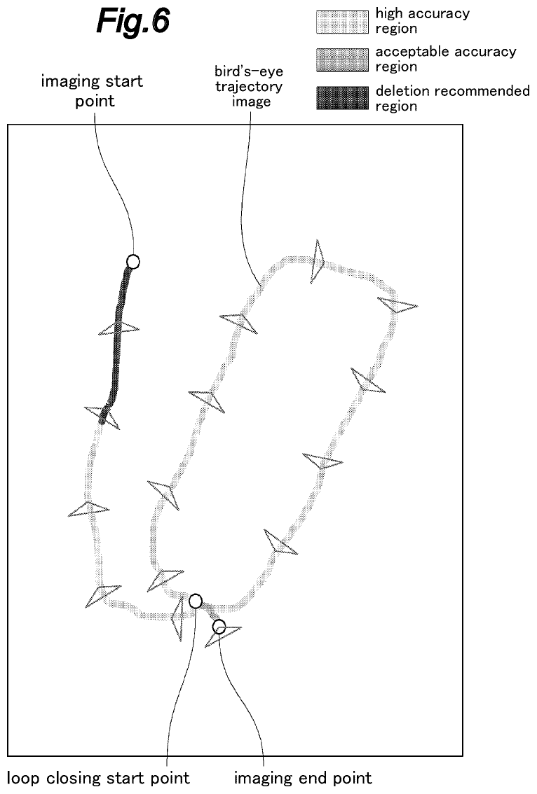

Next, a map image of a third example will be described. FIG. 6 is an explanatory diagram showing a bird's-eye trajectory image as a map image of the third example.

In the map image of the third example shown in FIG. 6, contrary to the first example (FIGS. 3 and 4), there is a region where the trajectory does not form a loop (non-loop region) followed by a region where the trajectory forms a loop (loop region). The loop region is set as a high accuracy region. Since the loop closing operation has been performed for a region from a loop closing start point, which is an imaging spot where a loop is closed, to an imaging start point, there is a region where the trajectory does not form a loop, but the loop closing operation has been performed therefor. Thus, in the non-loop region where the trajectory does not form a loop, a region near the loop region is set as the high accuracy region, while a region near the imaging start point, i.e., the region distant from the loop closing start point, is set as the deletion-recommended region.

In the present embodiment, a processed region for which the loop closing operation has been performed is divided into a high accuracy region and a deletion-recommended region. However, in some cases, an acceptable accuracy region may be set between the high accuracy region and the deletion-recommended region according to the distant amount from the loop closing start point.

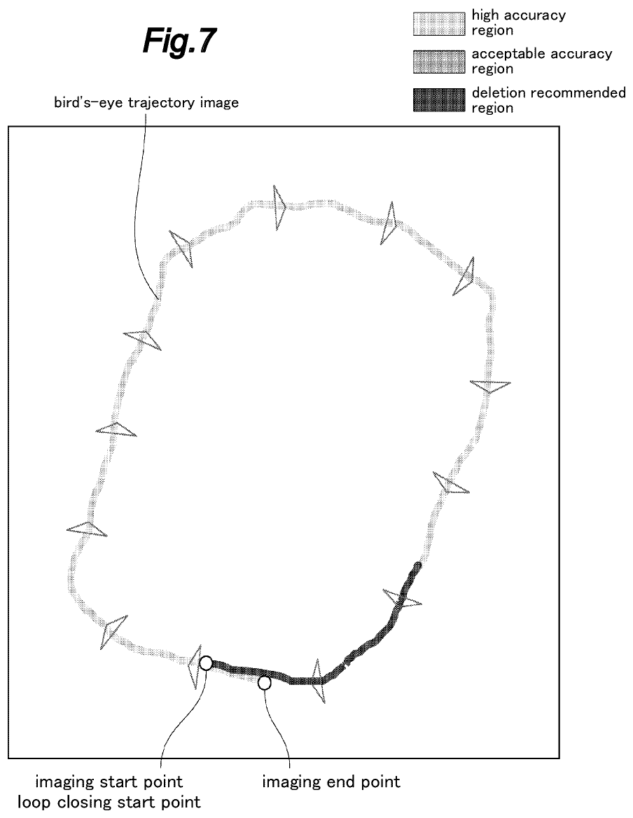

Next, a map image of a fourth example will be described. FIG. 7 is an explanatory diagram showing a bird's-eye trajectory image as a map image of the fourth example.

In the map image shown in FIG. 7, an entire region from an imaging start point to an imaging end point is included in a region where the trajectory forms loops (loop region). Thus, the loop closing operation has been performed for the entire region from the imaging start point to the imaging end point. However, as the loop has a rather large size in this example, a region near the imaging start point, which is distant from the loop closing start point, is set as the deletion-recommended region, and the remaining region is set as the high accuracy region.

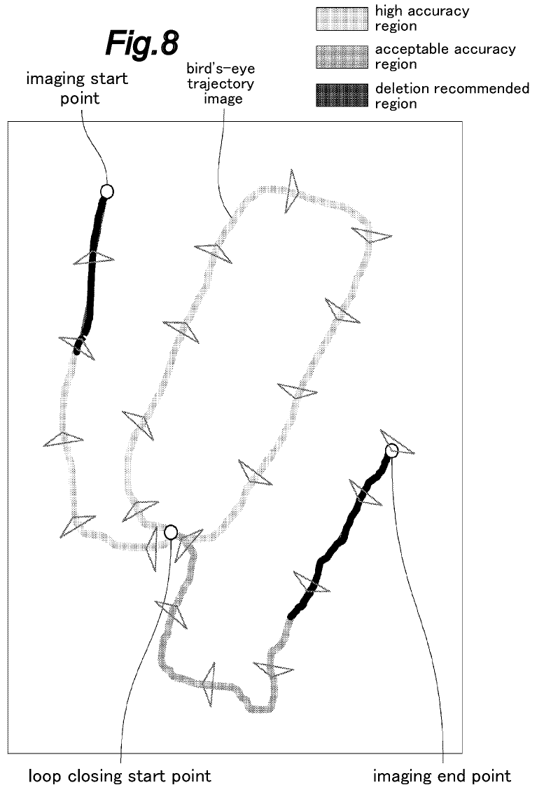

Next, a map image of a fifth example will be described. FIG. 8 is an explanatory diagram showing a bird's-eye trajectory image as a map image of the fifth example.

In the map image of the fifth example shown in FIG. 8, similarly to the map images of the first example (FIGS. 3 and 4), there is a region where the trajectory forms a loop (loop region) followed by a region where the trajectory does not form a loop (non-loop region). Furthermore, in this example, similarly to the third example (FIG. 6), there is a non-loop region where the trajectory does not form a loop followed by a loop region where the trajectory forms a loop. In this example, the loop closing operation has been performed for a region from a loop closing start point, which is an imaging spot where a loop is closed, to an imaging start point. In a processed region, for which the loop closing operation has been performed, a region near the imaging start point, which is distant from the loop closing start point, is set as the deletion-recommended region, and the remaining region is set as the high accuracy region. In an unprocessed region, for which the loop closing operation has not been performed, a region near the imaging end point, which is distant from the loop closing start point, is set as the deletion-recommended region, and the remaining region is set as the acceptable accuracy region.

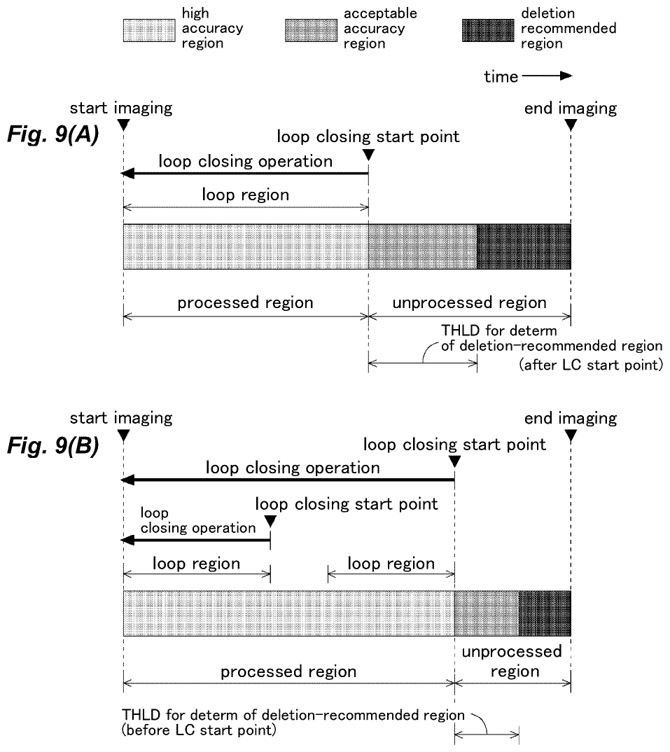

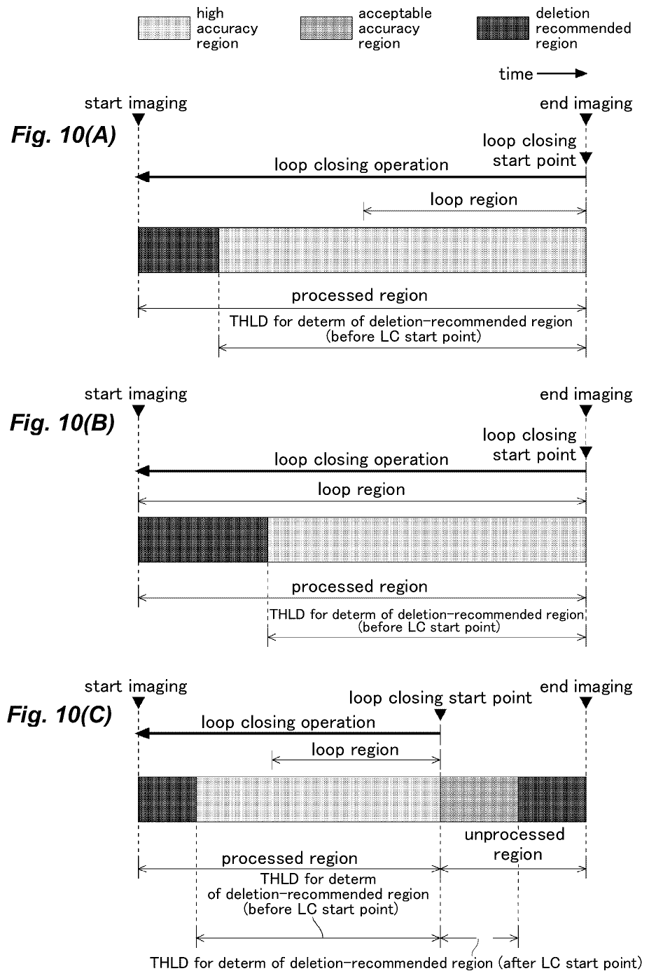

Next, timeline images will be described. FIGS. 9 and 10 are each an explanatory diagram showing examples of timeline images.

In the present embodiment, timeline images are generated and presented to a user. A timeline image visualizes the accuracy of point cloud image data (measurement results), which is generated from captured image data of each time of imaging, along a time axis. Specifically, in the timeline image, the high accuracy region, acceptable accuracy region, and deletion-recommended region in the time axis are visualized in different colors. For example, the high accuracy region and acceptable accuracy region are visualized in light blue and green, respectively, and the deletion-recommended region is visualized in red. Preferably, different regions in a timeline image are visualized in the same colors as the map image (FIGS. 3-8).

FIG. 9(A) shows a timeline image for the first example (FIGS. 3 and 4). FIG. 9(B) shows a timeline image for the second example (FIG. 5). FIG. 10(A) shows a timeline image for the third example (FIG. 6). FIG. 10(B) shows the timeline image for the fourth example (FIG. 7). FIG. 10(C) shows the timeline image for the fifth example (FIG. 8).

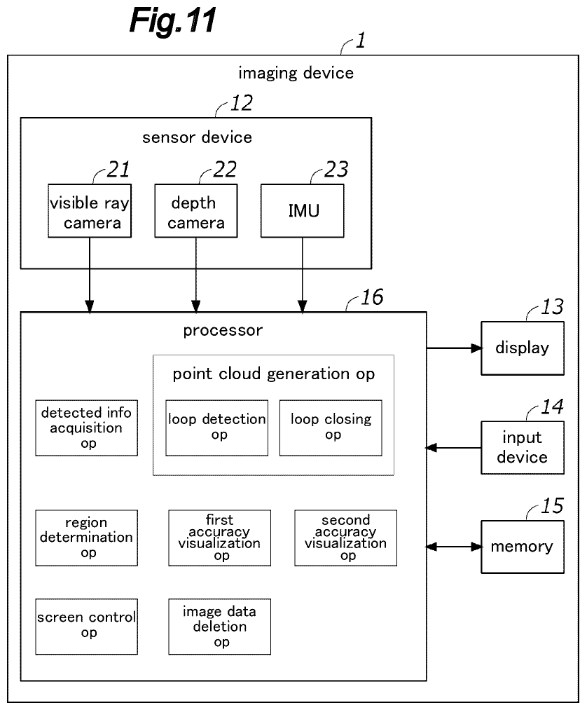

Next, a schematic configuration of the imaging device 1 will be described. FIG. 11 is a block diagram showing a schematic configuration of the imaging device 1.

The imaging device 1 includes, in addition to the sensor device 12, a display 13 (display), an input device 14, a memory 15 (storage), and a processor 16 (CPU).

The sensor device 12 includes, in addition to the visible ray camera 21, a depth camera 22 and an IMU 23 (Inertial Measurement Unit). The depth camera 22 is a stereo camera that detects infrared light to capture images of a subject, and outputs depth information (distance images) as results of the detection. The results of the detection output from the depth camera 22 can be used to measure the distance to the subject. In addition to a stereo camera, any other type of camera capable of acquiring depth information, such as LiDAR, may be used as the depth camera 22 as well. The IMU 23 detects 3D angular velocity and acceleration. Results of the detection from the IMU 23 can be used to measure the amounts of movement and rotation of the imaging device 1. In some embodiments, the visible ray camera 21, depth camera 22, and IMU 23 may not be integrated into a single sensor unit. In other embodiments, the sensor device 12 may be configured to include only the visible ray camera 21, without the depth camera 22 and IMU 23.

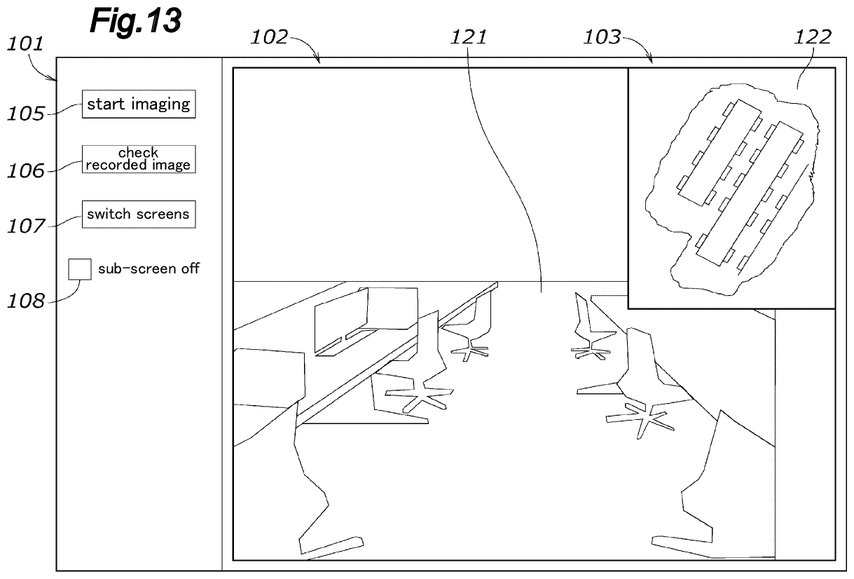

The display 13 displays screens such as an imaging screen 101 to present to a user various types of information related to the imaging work (FIG. 13). The input device 14 is used by a user to perform input operations. The input device 14 may include a keyboard, a mouse, a touch pad, and a touch screen. The imaging device 1 which is implemented as a tablet includes a touch screen display consisting primarily of both a touch screen as the input device 14 and a display panel as the display 13.

The memory 15 stores computer-readable programs that is executable by a processor 16. The memory 15 also stores captured image data for each imaging spot. The captured image data includes captured images provided from the visible ray camera 21, results of the detection provided from the depth camera 22 and IMU 23 imaging times (the times when images are captured), and feature amounts extracted from captured images. Moreover, the memory 15 stores processing information related to the status of performance of the loop closing operation. The processing information includes information on whether or not the loop closing operation has been performed for each imaging spot. The memory 15 further stores results of the measurement generated by the processor 16.

The processor 16 performs various processing operations by executing the programs stored in the memory 15. In the present embodiment, the processor 16 performs operations such as a detected information acquisition operation, a point cloud generation operation, a first accuracy visualization operation, a second accuracy visualization operation, a screen control operation, and an image data deletion operation.

In the detected information acquisition operation, the processor 16 acquires captured images provided from the visible ray camera 21. In this operation, the processor 16 also acquires results of the detection provided from the depth camera 22 and IMU 23.

In the point cloud generation operation (3D measurement operations), based on the images of the spots captured by the visible ray camera 21 on a spot-by-spot basis, the processor 16 generates point cloud image data (environmental map) as 3D space information on the measurement target site using an SLAM method. In addition to providing the point cloud image data, the point cloud generation operation involves a self-position estimation operation to estimate self-positions; that is, positions of imaging spots.

The point cloud generation operation includes a loop detection operation. In the loop detection operation, the processor 16 detects that the trajectory (movement path) of the device forms a loop, i.e., that the device has returned to a spot where an image has been previously captured. The detection of a spot where an image has been previously captured does not involve comparing the currently-captured image with a preset specific captured image, but involves detecting that the currently-captured image is similar to a past captured image to thereby determine that the imaging device has returned to a corresponding spot where an image has been previously captured. This similarity may be determined based on feature amounts extracted from captured images.

The point cloud generation operation includes a loop closing operation. When detecting a loop in the loop detection operation, the processor 16 performs the loop closing operation. In the loop closing operation, assuming that a result of self-position estimation operation (i.e., a past position acquired at the time of previous imaging) is a correct position of the previously imaged spot, the processor 16 corrects the position of each of the imaged spots on the trajectory from the current position to the past position.

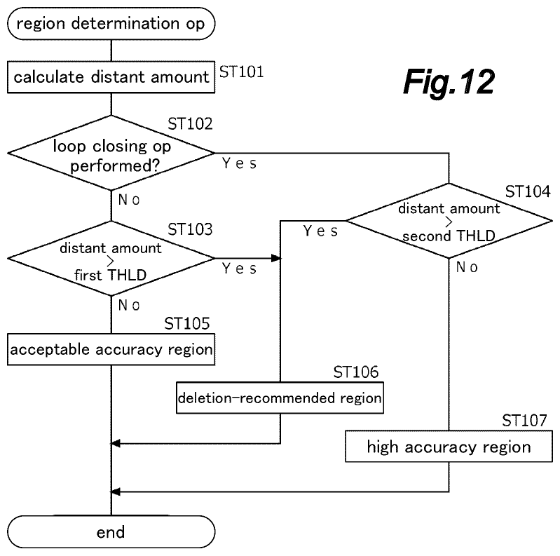

In the region determination operation, the processor 16 performs operations including: calculating a distant amount from a start point of the loop closing operation to a target imaging spot, as an indicator of the accuracy of point cloud image data (measurement results) generated from captured image data of the imaging spots; and comparing the distant amount for the target imaging spot with a predetermined criterion to thereby determine which region the target imaging spot falls within, the high accuracy region, acceptable accuracy region, or deletion-recommended region (FIG. 12).

In the first accuracy visualization operation, the processor 16 generates map images (FIGS. 3 to 8). A map image visualizes the accuracy of point cloud image data generated from captured image data for each imaging spot along a trajectory. Specifically, in the map image, the high accuracy region, acceptable accuracy region, and deletion-recommended region along the trajectory are visualized in different colors. The map image may also be a bird's-eye point cloud trajectory image (FIG. 3) or a bird's-eye trajectory image (FIGS. 4 to 8).

In the second accuracy visualization operation, the processor 16 generates timeline images (FIGS. 9 and 10). A timeline image visualizes the accuracy of point cloud image data generated from captured image data for each imaging spot (time of imaging) along a time axis. Specifically, a timeline image visualizes the high accuracy region, acceptable accuracy region, and deletion-recommended region along the time axis during an imaging work period from the imaging start time (the time at which an imaging start point is imaged) to the imaging end time (the time at which an imaging end point is imaged) in different colors.

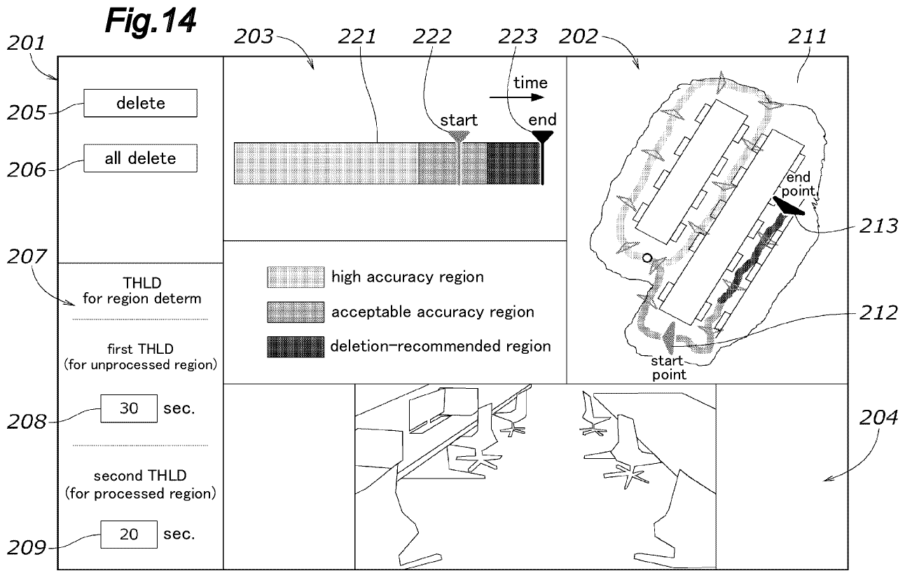

In the screen control operation, the processor 16 controls the screen displayed on the display 13. In the present embodiment, the processor 16 generates an imaging screen 101 (FIG. 13) and an image data adjuster screen 201 (FIG. 14) and causes the display 13 to display the generated screens.

In the image data deletion operation, in response to a user's operation on the image data adjuster screen 201 (FIG. 14) to designate a deletion region, the processor 16 deletes captured image data included in the designated deletion region or deletion-recommended region.

In the present embodiment, the imaging device 1 performs the 3D measurement operation (point cloud generation operation). However, the 3D measurement operation may also be performed by a server device (not shown) that can communicate with the imaging device 1.

Next, the region determination operation performed by the processor 16 will be described. FIG. 12 is a flowchart showing a procedure of the region determination operation.

In the region determination operation, the processor performs operations including: calculating a distant amount from a start point of the loop closing operation to a target imaging spot, as an indicator of the accuracy of point cloud image data (measurement results) generated from captured image data of the imaging spots; and comparing the distant amount for the target imaging spot with a predetermined criterion to thereby determine which region the target imaging spot falls within, the high accuracy region, acceptable accuracy region, or deletion-recommended region. When the target imaging spot is included in a processed region, for which the loop closing operation has been performed, a criterion for the processed region (first threshold) is used as the criterion for region determination. When the target imaging spot is included in an unprocessed region, for which the loop closing operation has not been performed, a criterion for the unprocessed region (second threshold) is used as the criterion for region determination.

Specifically, first, the processor 16 calculates a distant amount for a target imaging spot (i.e., an imaging spot for which the region determination is to be made) (ST101). The distant amount may be a time which has elapsed from when the start point of the loop closing operation was imaged to when the target imaging spot is imaged. The distant amount may be a distance between the start point of the loop closing operation and the target imaging spot (along the trajectory). The distant amount may be a shooting count which is a number of times the shooting has been performed (i.e., a number of frames) between the start point of the loop closing operation and the target imaging spot. The distant amount may be a key frame count which is a number of key frames of an SLAM method captured between the start point of the loop closing operation and the target imaging spot.

Next, the processor 16 determines whether the target imaging spot is included in the processed region, for which the loop closing operation has been performed (ST102).

When determining that the target imaging spot is not included in the processed region, (i.e., the target imaging spot is included in the unprocessed region) (No in ST102), the processor 16 determines whether or not the distant amount is equal to or greater than a first threshold value (ST103). When determining that the distant amount is less than the first threshold (No in ST103), the processor 16 determines that the target imaging spot falls within the acceptable accuracy region (ST105). When determining that the distant amount is equal to or greater than the first threshold value (Yes in ST103), the processor 16 determines that the target imaging spot falls within the deletion-recommended region (ST106).

When determining that the target imaging spot is included in the processed region, for which the loop closing operation has been performed (Yes in ST102), the processor 16 determines whether or not the distant amount is equal to or greater than the second threshold (ST104). When determining that the distant amount is less than the second threshold (No in ST104), the processor 16 determines that the target imaging spot falls within the high accuracy region (ST107). When determining that the distant amount is equal to or greater than the second threshold value (Yes in ST104), the processor 16 determines that the target imaging spot falls within the deletion-recommended region (ST106).

In this way, the processor 16 performs the region determination operations for each imaging spot, determines the high accuracy region, acceptable accuracy region, and deletion-recommended regions on the trajectory, and sets the high accuracy regions, acceptable accuracy regions, and determines the deletion-recommended regions within the imaging work period from the imaging start time to the imaging end time.

Next, the imaging screen 101 displayed on the display 13 will be described. FIG. 13 is an explanatory diagram showing the imaging screen 101.

The imaging screen 101 includes a main window 102 (main image display frame) and a sub-window 103 (sub-image display frame). The main window 102 and the sub-window 103 indicate images with different display magnifications; that is, the image being enlarged in the main window 102 and reduced in the sub-window 103.

The main window 102 and sub-window 103 display a captured image 121 and a map image 122, respectively. The captured image 121 is a current captured image; that is, an image captured and output from the visible ray camera 21 in real time. The map image 122 is a bird's-eye point cloud image, i.e., an image (rendered image) indicating spots in the point cloud data as seen from an overhead viewpoint. The map image 122 may be a bird's-eye point cloud trajectory image (FIG. 3) or a bird's-eye trajectory image (FIGS. 4 to 8), not the bird's-eye point cloud image.

The imaging screen 101 includes a “start imaging” button 105 and a “check recorded image” button 106. When a user operates the “start imaging” button 105, the imaging device 1 starts imaging with the visible ray camera 21 and stores captured images in the memory 15. When a user operates the “check recorded image” button 106, the screen transitions to a shotting status check screen (FIG. 14). Upon finishing the imaging work, a user can cause the screen to transition to the shotting status check screen, thereby checking a status of shooting. During the imaging work, the user can also pause the imaging work when necessary to cause the screen to transition to the shotting status check screen, thereby checking a current status of shooting. In this case, the user can cause the screen to return to the imaging screen and resume the imaging work.

The imaging screen 101 includes a “switch screens” button 107, and a checkbox 108 used to control the sub-window 103. This feature allows a user to operate the “switch screens” button 107, thereby switching the imaging screen 101 between (i) a status (shown in FIG. 13) in which the captured image 121 is displayed as an enlarged image in the main window 102 while the map image 122 is displayed as a reduced image in the sub-window 103 and (ii) a status in which the map image 122 is displayed as an enlarged image in the main window 102 while the captured image 121 is displayed as a reduced image in the sub-window 103. When a user checks the checkbox 108, the status of the imaging screen 101 transitions such that the sub-window 103 is not displayed.

Next, the image data adjuster screen 201 displayed on the display 13 will be described. FIG. 14 is an explanatory diagram showing the image data adjuster screen 201.

The image data adjuster screen 201 includes a first image data adjuster 202 and a second image data adjuster 203.

The first image data adjuster 202 indicates a map image 211. The map image 211 is generated by the first accuracy visualization operation. The map image visualizes the accuracy of point cloud image data (measurement results) generated from captured image data for each imaging spot, along a trajectory, i.e., a line connecting imaging spots. Specifically, in the map image 211, the high accuracy region, acceptable accuracy region, and deletion-recommended region in the trajectory are visualized in different colors. For example, the high accuracy region and acceptable accuracy region are visualized in light blue and green, respectively, and the deletion-recommended region is visualized in red.

In the example shown in FIG. 14, the map image 211 is a bird's-eye point cloud trajectory image (FIG. 3). However, the map image 211 may be a bird's-eye trajectory image (FIGS. 4 to 8), which is formed by removing the bird's-eye point cloud image from the bird's-eye point cloud trajectory image.

The first image data adjuster 202 includes a start point symbol 212 and an end point symbol 213, which represent imaging spots which correspond to a start point and end point of a deletion region where the captured image data is to be deleted. Specifically, when a user selects imaging spot symbols on the bird's-eye trajectory image in the map image 211, which correspond to the start and end points of a deletion region where the captured image data is to be deleted, the start point symbol 212 and end point symbol 213 are indicated on the selected imaging spot symbols.

When the first image data adjuster 202 indicates the map image 211 including a trajectory and a user selects a deletion-recommended region on the trajectory, for example, by clicking on the deletion-recommended region, the deletion-recommended region is designated as a deletion region where the captured image data is to be deleted. Upon the designation, the start point symbol 212 and the end point symbol 213 move to the start and end points of the deletion-recommended region. In some cases, a user may operate on a deletion-recommended region and an acceptable accuracy region in the map image 211, to thereby designate both the deletion-recommended region and acceptable accuracy region as a deletion region where the captured image data is to be deleted.

The second image data adjuster 203 indicates a timeline image 221 (FIGS. 9 and 10). The timeline image 221 is generated by the second accuracy visualization operation. The timeline image 221 visualizes the accuracy of the point cloud image data (measurement results) generated from captured image data for each imaging time (i.e., the time when shooting is performed), along the time axis. Specifically, in timeline image 221, the high accuracy region, acceptable accuracy region, and deletion-recommended region along the time axis are visualized in different colors. For example, the high accuracy region and acceptable accuracy region are visualized in light blue and green, respectively, and the deletion-recommended region is visualized in red.

The first and second image data adjusters 202 and 203 preferably visualize the high accuracy region, acceptable accuracy region, and deletion-recommended region in the same corresponding colors. As shown in FIGS. 9 and 10, the timeline image 221 may further include characters or figures which represent a processed region, for which the loop closing operation has been performed, a starting point of the loop closing operation, and a region where the trajectory forms a loop (loop region).

The second image data adjuster 203 includes a start point symbol 222 and an end point symbol 223, which represent times of imaging which correspond to a start point and end point of a deletion region where the captured image data is to be deleted. A user can change the times of imaging which correspond to a start point and end point of a deletion region where the captured image data is to be deleted, by moving (e.g., by sliding) the start point symbol 222 and end point symbol 223.

When the second image data adjuster 203 indicates the timeline image 221 including a trajectory and a user selects a deletion-recommended region on the trajectory, for example, by clicking on the deletion-recommended region, the deletion-recommended region is designated as a deletion region where the captured image data is to be deleted. Upon the designation, the start point symbol 222 and the end point symbol 223 move to the start and end points of the deletion-recommended region. In some cases, a user may operate on a deletion-recommended region and an acceptable accuracy region in the timeline image 221, to thereby designate both the deletion-recommended region and acceptable accuracy region as a deletion region where the captured image data is to be deleted.

An operation for designating a deletion region may be performed on either the first or second image data adjuster 202 or 203. When the operation of designating a deletion region is performed on either the first or second image data adjuster 202 or 203, what is designated by this operation is reflected in the other adjuster. For example, when a user operates the start point symbol 212 and the end point symbol 213 in the first image data adjuster 202 to designate the deletion region, the start point symbol 222 and the end point symbol 223 in the second image data adjuster 203 are displayed at time points (times of imaging) which correspond to the region designated in the first image data adjuster 202.

The image data adjuster screen 201 includes a captured image indicator 204. The captured image indicator 204 displays a captured image corresponding to the time of imaging and imaging spot designated by a user by operating the first and second image data adjusters 202 and 203. Specifically, when a user performs an operation (e.g., a tapping operation) on the first image data adjuster 202 to designate a position on the map image 211, the captured image of the imaging spot at the designated position is displayed. When a user performs an operation (e.g., a tapping operation) on the second image data adjuster 203 to designate a time point on the timeline image 221, the captured image of the designated time of imaging is displayed.

The image data adjuster screen 201 includes a “Delete” button 205 and an “All Delete” button 206. When a user operates the “Delete” button 205, the captured image data included in the region designated in the first and second image data adjusters 202 and 203 by the user is deleted. When a user operates the “All Delete” button 206, the captured image data included in the deletion-recommended region is deleted.

The image data adjuster screen 201 includes a threshold setter 207 for setting thresholds used in the region determination operation. The threshold setter 207 includes a first threshold entry field 208 and a second threshold entry field 209. The first threshold entry field 208 allows a user to enter a first threshold value. The second threshold entry field 209 allows a user to enter a second threshold value.

The first and second thresholds are used as determination criteria in the region determination operation to determine whether a target imaging spot falls within a deletion-recommended region (i.e., a region where the accuracy of the point cloud image data generated from the captured image data is estimated to be lower than an acceptable accuracy region). In particular, the first threshold is used as a determination criterion for unprocessed regions, for which the loop closing operation has not been performed. The second threshold is used as a determination criterion for processed regions, for which the loop closing operation has been performed.

In the example shown in FIG. 14, the first and second thresholds are set as the distant amounts concerning time. The distant amount concerning time represents a time which has elapsed from when a start point of the loop closing operation was imaged to when a target imaging spot is imaged. In an unprocessed region, for which the loop closing operation has not been performed, when the distant amount is equal to or greater than the first threshold, the device determines that the target imaging spot falls within a deletion-recommended region. In a processed region, for which the loop closing operation has been performed, when the distant amount is equal to or greater than the second threshold, the device determines that the target imaging spot falls within a deletion-recommended region.

In this way, the configuration of the present embodiment allows a user to set different values as the first and second thresholds, where the first threshold is a determination criterion for unprocessed regions, for which the loop closing operation has not been performed, and the second threshold is a determination criterion for unprocessed regions, for which the loop closing operation has been performed.

The distant amount may be a distance (distance along a trajectory) between the start point of the loop closing operation and the target imaging spot. The distant amount may be a shooting count which is a number of times the shooting has been performed between the start point of the loop closing operation and the target imaging spot. The distant amount may be a key frame count which is a number of key frames of an SLAM method captured between the start point of the loop closing operation and the target imaging spot. The device may be configured to allow a user to change the type of distant amount (time, distance, number of frames, number of key frames) by operating on a settings screen (not shown) or on the image data adjuster screen 201.

The device may be configured such that the first and second threshold entry fields 208 and 209 first display predetermined first and second thresholds (initial values), and a user is allowed to change the first and second thresholds as necessary. In some cases, the device may be configured such that both the first threshold entry field 208 and the second threshold entry field 209 can receive an entered threshold, and when one of the first and second thresholds is entered, the other threshold is automatically determined based on the entered threshold and set. In this case, the first or second threshold value is preferably determined according to a predetermined calculation formula such that, regardless of which threshold is entered, the first threshold is greater than the second threshold.

In the example shown in FIG. 14, one deletion-recommended region and one deletion region designated by the user where the captured image data is to be deleted are set in the first and second image data adjusters 202 and 203. However, two or more deletion regions where captured image data is to be deleted may be set. For example, like the example shown in FIG. 8, two deletion-recommended regions may be set on the imaging start point side and the imaging end point side, with two deletion regions designated by a user set therein.

In the example shown in FIG. 14, the image data adjuster screen 201 shows both the first and second image data adjusters 202 and 203. However, the image data adjuster screen 201 may show either one of the two.

In the present embodiment, the device presents to a user an image that visualizes a deletion-recommended region in which accuracy of measurement results is estimated to be insufficient, allowing the user to operate the device to delete captured image data included in the deletion-recommended region or a deletion region designated by the user. However, in some cases, the device may skip the operation for presenting an image that visualizes a deletion-recommended region to a user, and automatically delete captured image data included in the deletion-recommended region, without any user's operation. For example, in this case, a user sets the first threshold and second threshold in advance so that, when the imaging ends, the processor can execute macroinstructions that automatically delete only data of the deletion-recommended region based on the first threshold and second threshold.

While specific embodiments of the present disclosure are described herein for illustrative purposes, the present disclosure is not limited to those specific embodiments. Various changes, substitutions, additions, and omissions may be made to elements of the embodiments without departing from the scope of the invention. Moreover, elements and features of the different embodiments may be combined with each other to yield another embodiment of the present disclosure.

### INDUSTRIAL APPLICABILITY

A device, a method, and a program for processing captured image data according to the present disclosure, have an effect of allowing a user to easily identify a region in which accuracy of measurement results is likely to be insufficient, in stored captured image data, thereby enabling effective deletion of captured image data to be deleted, and are useful as a device, a method, and a program for processing captured image data which processes captured image data which has been acquired by shooting imaging spots in a measurement target site spot by spot with a camera, thereby allowing a 3D measurement operation to be performed for generating 3D space information on the measurement target site.

### GLOSSARY

1 imaging device (device for processing captured image data)
11 imaging device body
12 sensor device
13 display
14 input device
15 memory
16 processor
16 processor
21 visible ray
22 depth camera
101 imaging screen
201 captured image data adjustment screen
202 first image data adjuster
203 second image data adjuster
204 captured image indicator
205 “Delete” button
206 “All Delete” button
207 threshold setter
208 first threshold entry field
209 second threshold entry field
211 map image
212 start point symbol
213 end point symbol
221 timeline image
222 start point symbol
223 end point symbol

1. A device for processing captured image data in which a processor processes captured image data which has been acquired by shooting imaging spots in a measurement target site spot by spot with a camera, thereby allowing a 3D measurement operation to be performed for generating 3D space information on the measurement target site, the device comprising:
a storage for storing captured image data and processing information as to a status of performance of a loop closing operation in the 3D measurement operation; and
a display for displaying a screen that indicates captured image data and the status of performance of the loop closing operation,
wherein the processor performs operations to:
cause the display to display an image that visualizes a deletion-recommended region in a trajectory connecting imaging spots, based on the processing information, wherein the deletion-recommended region is a region within an unprocessed region for which the loop closing operation has not been performed and/or a region within a processed region for which the 4 loop closing operation has been performed, and in which accuracy of results of the 3D measurement operation based on captured image data of the imaging spots is estimated to be insufficient.

2. The device as claimed in claim 1, wherein the operations performed by the processor comprise:
calculating a distant amount from a start point of the loop closing operation to a target imaging spot, as an indicator of the accuracy of results of the 3D measurement operation based on captured image data of the imaging spots; and
comparing the distant amount for the target imaging spot with a criterion predetermined for the unprocessed region to thereby determine whether or not the imaging spot falls within the deletion-recommended region.

3. The device as claimed in claim 1, wherein the operations performed by the processor comprise:
visualizing the deletion-recommended region and the other region in the trajectory in the unprocessed region in different display forms.

4. The device as claimed in claim 3, wherein the difference in the display form includes at least one of different colors, patterns or animations.

5. The device as claimed in claim 2, wherein the operations performed by the processor comprise calculating, as the distant amount, any one of the followings:
a time which has elapsed from when the start point of the loop closing operation was imaged to when the target imaging spot is imaged;
a distance between the start point of the loop closing operation and the target imaging spot;
a shooting count which is a number of times the shooting has been performed between the start point of the loop closing operation and the target imaging spot; and
a key frame count which is a number of key frames of an SLAM method captured between the start point of the loop closing operation and the target imaging spot.

6. The device as claimed in claim 1, wherein the operations performed by the processor comprise visualizing the deletion-recommended region in the trajectory in both the unprocessed region, for which the loop closing operation has not been performed, and a processed region for which the loop closing operation has been performed.

7. (canceled).

8. The device as claimed in claim 1,
wherein the processor performs operations to:
cause the display to display a screen indicating an image data adjuster for adjusting the captured image data stored and accumulated in the storage, wherein the image data adjuster includes an image that visualizes accuracy of results of the 3D measurement operation based on captured image data of the imaging spots; and
in response to a user's operation on the image data adjuster to designate a deletion region, delete the captured image data included in the deletion region.

9. A method for processing captured image data in which a processor processes captured image data which has been acquired by shooting imaging spots in a measurement target site spot by spot with a camera, thereby allowing a 3D measurement operation to be performed for generating 3D space information on the measurement target site, the method comprising:
the processor performing an operation to:
cause a display to display an image that visualizes a deletion-recommended region in a trajectory connecting imaging spots, based on the processing information, wherein the deletion-recommended region is a region within an unprocessed region for which a loop closing operation in the 3D measurement operation has not been performed and/or a region within a processed region for which the 4 loop closing operation has been performed, and in which accuracy of results of the 3D measurement operation based on captured image data of the imaging spots is estimated to be insufficient based on processing information as to a status of performance of the loop closing operation.

10. (canceled).

11. The method as claimed in claim 9, wherein
the processor performing operations to:
cause a display to display a screen indicating an image data adjuster for adjusting the captured image data stored and accumulated in a storage, wherein the image data adjuster includes an image that visualizes accuracy of results of the 3D measurement operation based on captured image data of the imaging spots; and
in response to a user's operation on the image data adjuster to designate a deletion region, delete the captured image data included in the deletion region.

12. (canceled).

13. (canceled).

14. (canceled).
